(19) United States
(12) Patent Application Publication
(10) Pub. No.: US 2017/0234519 A1
(43) Pub. Date: Aug. 17, 2017

(54) LED LAMP UNIT

(71) Applicant: Chiwai YEUNG, Shatin, Hong Kong (CN)

(72) Inventor: Chiwai YEUNG, Shatin, Hong Kong (CN)

(21) Appl. No.: 15/519,421

(22) PCT Filed: Oct. 14, 2015
(86) PCT No.: PCT/CN2015/000694

§ 371 Date: Apr. 14, 2017

(30) Foreign Application Priority Data
Oct. 17, 2014 (CN) 201410555199.4

(51) Int. Cl. F21V 29/70; F21V 3/00; F21K 9/232; F21K 9/237; F21K 9/235; F21V 23/06; F21V 7/22

(52) U.S. Cl. CPC F21V 29/70; F21V 23/06; F21V 3/00; F21V 7/22; F21K 9/237; F21K 9/235; F21K 9/232

(57) ABSTRACT

An LED lamp unit, comprising a light-emitting body having a hollow tube shape, a translucent cover and end caps. LED light-emitting elements are fixed on the light-emitting body and/or the translucent cover. The centers of the end caps are provided with opening holes, and at least one end of the light-emitting body is provided with an electrical connection component connected to the LED light-emitting elements, the electrical connection component extending out of the end cap, the end cap of the end provided with the electrical connection component being provided with an outwardly extending circumferential surface, ventilation holes being provided on the circumferential surface. The LED lamp unit has a simple structure, implements 360 degree omnidirectional illumination, and has a large light-emitting angle and high light-emitting efficiency. The LED lamp unit is provided with a heat dissipation channel in communication with the outside air, heat dissipation performance is good, and the service life of the LED lamp unit is increased.

### TECHNICAL FIELD

The present invention relates to an LED lamp unit.

### BACKGROUND

In recent years, various performance of the illuminating LED lamp has been improved considerably due to the continuous development of the LED technology. The LED lamp has become the trend in the future of the light source since it has a number of advantages such as long lifetime, high luminous efficiency, no UV radiation and lower energy consumption.

However, unlike the incandescent lamp and the like which could implement 360 degree omnidirectional illumination, the LED light source has directivity, so its illuminating effect, to a certain extent, is impacted when it replaces traditional light source such as the incandescent lamp or the like as a light source, especially when the LED is manufactured to be a daylight lamp having a traditional tube-shape, for example the “LED daylight lamp” disclosed in the Chinese patent which the publication number is CN102022651A. This LED daylight lamp comprises a lampshade, LED light source—assembly, an LED driving assembly, two end caps and a heat dissipating housing. The lampshade is connected to the heat dissipating housing, and the two end caps cover the lampshade and the heat dissipating housing which have been connected at their two ends respectively. The cross sections of the lampshade and the heat dissipating housing are both arc-shaped, and the lampshade and the heat dissipating housing form a cavity in which the LED light source components and the LED driving component are located. In this LED daylight lamp, the LEDs have to be arranged within a plane so as to meet the requirements for their heat dissipation. Thus, its light emitting area could merely cover 180 degree rather than 360 degree (i.e., it emits light from a plane instead of emitting light omnidirectionally), although it has a long straight tube-shape like the daylight lamp. Therefore, the LED daylight lamp in the prior art could not implement 360 degree omnidirectional illumination while meeting the requirements for the heat dissipation since the heat dissipating area and the light emitting area are contradictory.

### SUMMARY

The present invention aims to solve the technical problem of providing an LED lamp unit that could implement omnidirectional illumination as well as has good heat dissipation performance.

In order to solve the technical problem mentioned above, the present invention provides technical solutions as follows. The present invention provides an LED lamp unit comprising a light-emitting body having a hollow tube shape and a translucent cover enclosing the light-emitting body at its outside with a space therebetween. The light-emitting body and/or the translucent cover have LED light-emitting elements fixed on them. The LED lamp unit is characterized in that: The two ends of the light-emitting body and the translucent cover have end caps fixed and connected to them. The end caps have opening holes at their centers which connect a hollow cavity inside the light-emitting body to external environment. At least one end of the light-emitting body is provided with an electrical connection component which extends out of the end cap. The LED light-emitting elements on the light-emitting body are connected to the electrical connection component. The end cap at the end that has electrical connection component is provided with a circumferential surface which extends outwardly in the same direction as the extending direction of the light-emitting body and the translucent cover, and the circumferential surface is provided with ventilation holes which connect the hollow cavity inside the light-emitting body to outside air.

In order to make the overall structure more reasonable, the outer end of the circumferential surface of the end cap at the end that has electrical connection component is closed, and the outer end of the circumferential surface which is closed has a hole from which the electrical connection component protrudes.

To facilitate the connection between the lamp units, when only one end of the LED lamp unit has the electrical connection component, the end cap at the end that has no electrical connection component is also provided with a circumferential surface which extends outwardly in the same direction as the extending direction of the light-emitting body and the translucent cover, and the circumferential surface is provided with ventilation holes which connect the hollow cavity inside the light-emitting body to outside air.

Preferably, the outer end of the circumferential surface of the end cap at the end of the LED lamp unit that has no electrical connection component is closed.

In order to improve the light-emitting efficiency and the brightness uniformity, the outer surface of the light-emitting body is coated with reflective layer or fluorescent powder.

The end caps are provided with grooves for accommodating and fixing the light-emitting body and the translucent cover respectively to facilitate the fixing.

Preferably, the LED Light-emitting elements are fixed on the outer surface of the light-emitting body.

Compared with the technology in prior art, the present invention has advantages as follows: The LED lamp unit has a simple structure, implements 360 degree omnidirectional illumination, and has good heat dissipation performance due to the fact that it is provided with a heat dissipation channel in communication with the outside air, thereby increasing the service life of the LED lamp unit. Additionally, a plurality of this LED lamp units could be connected to each other to form lamps with various lengths or various shapes, and thus the range of applications is widened.

### BRIEF DESCRIPTION OF THE DRAWINGS

FIG. 1 is a perspective view of the LED lamp unit according to the first embodiment of the present invention;

FIG. 2 is a sectional view of the LED lamp unit according to the first embodiment of the present invention;

FIG. 3 is an exploded view of the LED lamp unit according to the first embodiment of the present invention;

FIG. 4 is a perspective view of the LED lamp unit according to the second embodiment of the present invention;

FIG. 5 is a sectional view of the LED lamp unit according to the second embodiment of the present invention;

FIG. 6 is an exploded view of the LED lamp unit according to the third embodiment of the present invention;

FIG. 7 is a sectional view of the LED lamp unit according to the third embodiment of the present invention;

FIG. 8 is a perspective view of an LED lamp comprising the LED lamp unit according to the first embodiment of the present invention;

FIG. 9 is a sectional view of an LED lamp comprising the LED lamp unit according to the first embodiment of the present invention.

### DETAILED DESCRIPTION

In the following, further details of the present invention are described with reference to the drawings and embodiments.

### Embodiment 1

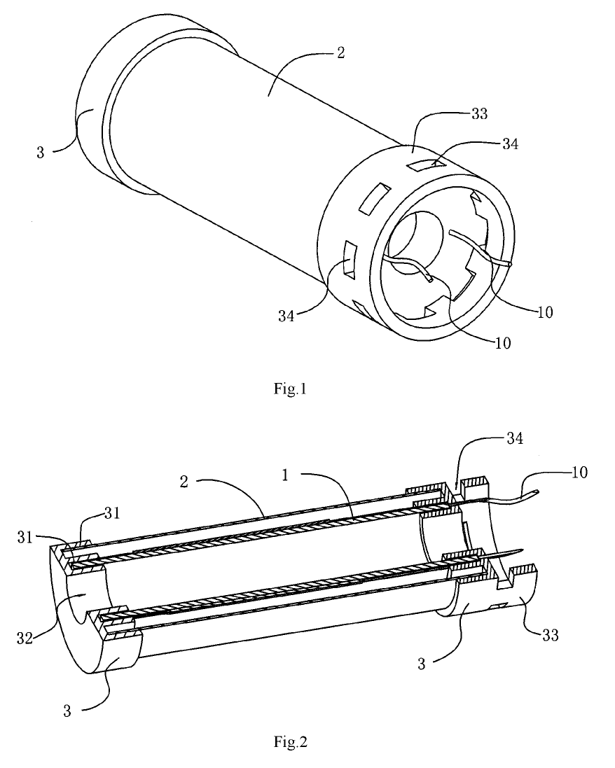

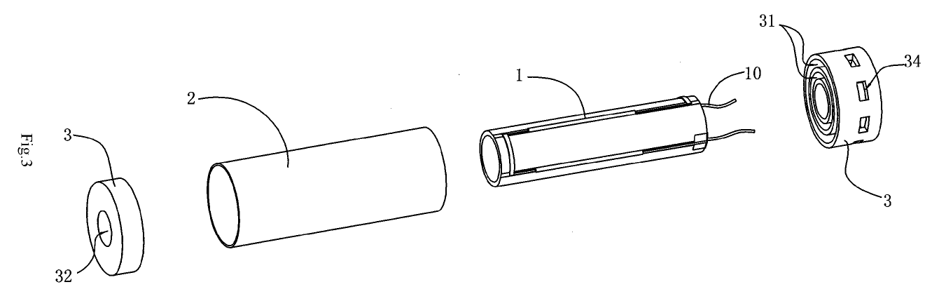

As illustrated in FIG. 1 to FIG. 3, the LED lamp unit according to the first embodiment of the present invention comprises a light-emitting body 1 having a hollow tube shape and a translucent cover 2. The light-emitting body 1 has openings at its two ends and a hollow cavity extending along its length. The light-emitting body 1 may be metal, or transparent material such as plastic, ceramic, glass and the like. A plurality of LED light-emitting elements are fixed on the out surface of the light-emitting body 1. The plurality of LED light-emitting elements are electrically connected to the connecting line or plug-in pieces at one end of the light-emitting body 1 through the printed circuit printed on the surface of the light-emitting body 1. As shown in FIG. 1 to FIG. 3, one end of the light-emitting body 1 in this embodiment is connected to a connecting line 10, and the plurality of LED light-emitting elements are connected to the connecting line 10. The out surface of the light-emitting body 1 is coated with reflective layer or fluorescent powder layer so that the luminous efficiency of the light-emitting body 1 is improved and its brightness is more uniform.

The light-emitting body 1 is enclosed by a translucent cover 2 at its outside. The translucent cover 2 matches the light-emitting body, encloses the light-emitting body 1 at its outside and extends along with the light-emitting body 1 in the same direction with a space between them. A cavity is formed between the translucent cover 2 and the light-emitting body 1. The translucent cover 2 is made of translucent material. The two ends of the light-emitting body 1 and the translucent cover 2 are enclosed by end caps 3 respectively and fixed to them. The end caps 3 include two circular grooves with a space therebetween which are provided to be inserted by the light-emitting body 1 and the translucent cover 2 respectively. And the end caps 3 have opening holes 32 at their centers which connect the hollow cavity inside the light-emitting body 2 to the external environment.

As illustrated in FIG. 1, an end cap 3 at one end of the light-emitting body 1 has a circumferential surface 33 which extends outwardly in the same direction as the extending direction of the translucent cover 2 and the light-emitting body 1. The circumferential surface 33 has ventilation holes 34 arranged evenly spaced in the axial direction of the circumferential surface 33. The connecting line 10 extends out of the end cap 3 and is located outside the LED lamp unit. The outside air enters one of the end caps 3 through its ventilation holes 34 or the hole enclosed by the circumferential surface 33, flows into the hollow cavity of the light-emitting body 1 through the opening hole 32 of the end cap 3, and then exits through the opening hole 32 at the center of the other end cap 3 at the other end, thereby forming a heat dissipation channel in communication with the external environment. The end of the light-emitting body 1 that has the connecting line 10, i.e., the end with the electrical connection component, is required to be connected to an external electrical connector or other lamp unit with its end surface, so this end must have the circumferential surface 33 extending in the same direction as the extending direction of the light-emitting body 1 and the translucent cover 2. And the circumferential surface 33 must have holes, otherwise the heat dissipation channel cannot form a loop. The outer end of the circumferential surface at this end may be not closed, or may be closed as long as the outer end has a hole from which the electrical connection component could protrude. And the end surface of the other end that has no electrical connection component may have no circumferential surface and the end cap 3 is connected to the external environment through the opening hole 32, or may have a circumferential surface 33. The outer end of the circumferential surface 33 may be closed or not. Nevertheless, there must be ventilation holes 34 on the circumferential surface 33 when the outer end of the circumferential surface 33 is closed.

More than two LED lamp units described above may be connected to each other so as to form a longer lamp tube. Alternatively, one LED lamp unit may be connected to a electrical connector through the electrical connection component to form an LED lamp. The LED Light-emitting elements may be arranged on the outer surface of the light-emitting body 1, the interior surface of the translucent cover 2, or the outer surface of the translucent cover 2. Alternatively, the LED light-emitting elements may be arranged on both of the translucent cover and the light-emitting body, as long as the light-emitting surfaces of the LED light-emitting elements face to the cavity formed between the light-emitting body and the translucent cover. In addition, at least two of the light-emitting body 1, the translucent cover 2 and the end caps may be formed integrally.

### Embodiment 2

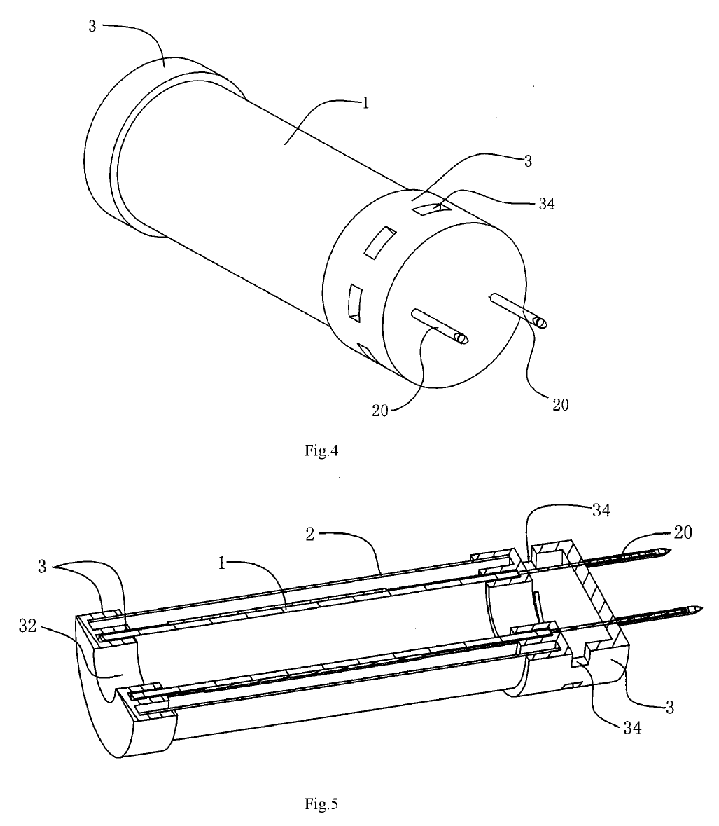

As illustrated in FIG. 4 to FIG. 5, the LED lamp unit according to the second embodiment of the present invention has the same structure as the LED lamp unit according to the first embodiment except for the fact that one end of the light-emitting body 1 in the second embodiment has an electrical connection component which is embodied as a pin 20, the end cap 3 at the end of the LED lamp unit 1 that has the pin 20 is provided with the circumferential surface 33, the outer end of the circumferential surface 33 is closed, and the circumferential surface 33 is provided with ventilation holes 34. The end cap 3 on the other end of the light-emitting body 1 and the translucent cover 2 have no circumferential surface. The rest portion of the LED lamp unit in this embodiment is the same as that of the first embodiment.

### Embodiment 3

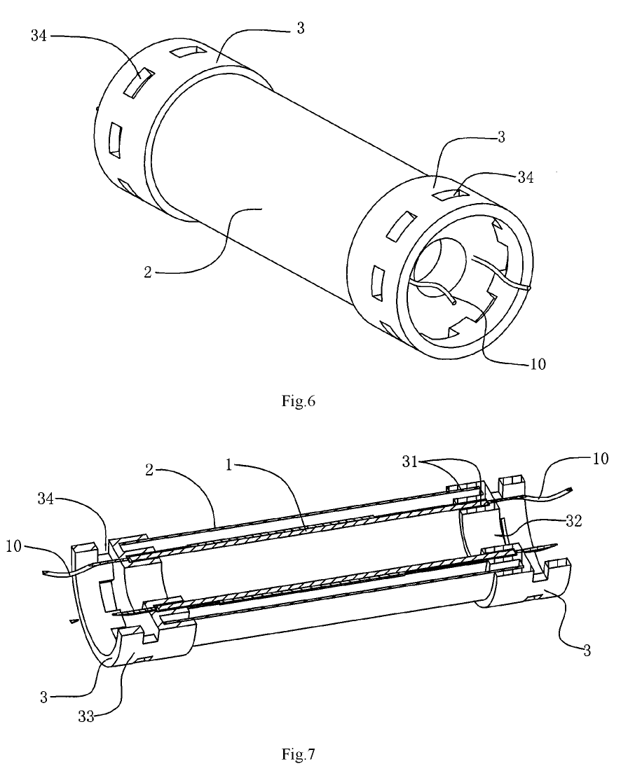

As illustrated in FIG. 6 and FIG. 7, the LED lamp unit according to the third embodiment has the same structure as the LED lamp unit according to the first embodiment except for the fact that both ends of the light-emitting body 1 have electrical connection components which are embodied as connecting lines 10, the end caps of both ends of the light-emitting body 1 and the translucent cover 2 have circumferential surfaces 33 which have ventilation holes 34 on them. The outer end of the circumferential surfaces 33 of the end caps at two ends may be not closed, or may also be closed obviously as long as there are holes from which the connecting lines 10 could protrude. A plurality of the LED lamp units could be connected to each other to form a lamp with a long tube shape, and the length of the lamp may be adopted as required.

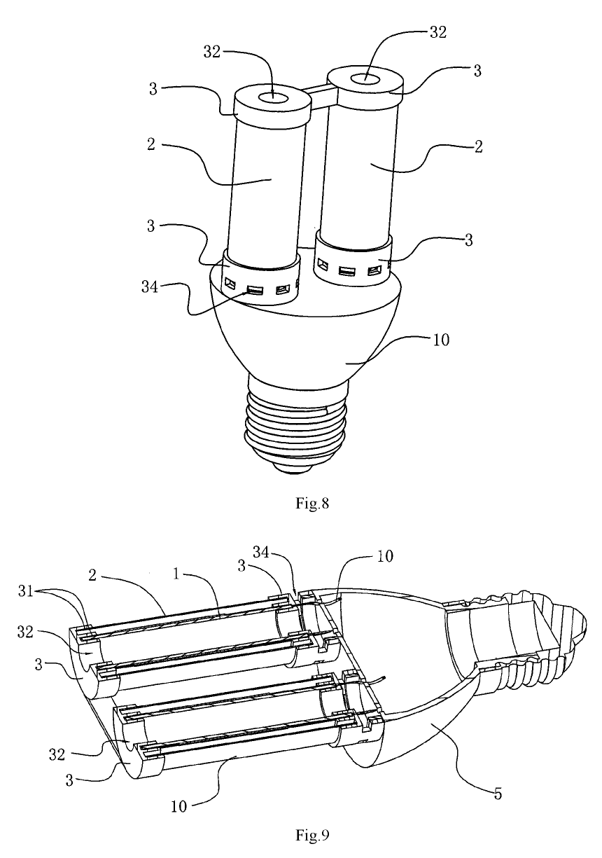

FIG. 8 and FIG. 9 illustrate an LED lamp comprising the LED lamp unit according to the first embodiment of the present invention. The LED lamp includes an electrical connector 5 on which two LED lamp units are fixed. The LED lamp units are connected to a driver in the electrical connector 5 through the connecting lines 10 protruding from the end caps 3, such that the LED light-emitting elements on the light-emitting bodies 1 are driven to emit light. The end caps at other ends of the LED lamp units are connected to each other. Obviously, the person skilled in the art could deduced that a plurality of LED lamp units may be connected and fixed together. The LED lamp units may also be connected end to end so as to form an LED lamp with a circular shape or other shape. The user could make any combination of the LED lamp units as required.

The LED lamp unit has a simple structure, implements 360 degree omnidirectional illumination, and has a large light-emitting angle and high light-emitting efficiency. Moreover, the LED lamp unit is provided with a heat dissipation channel in communication with the outside air and thus heat dissipation performance is good, thereby increasing the service life of the LED lamp unit. Additionally, a plurality of this LED lamp units could be connected to each other to form lamps with various lengths or various shapes, and thus the range of applications is widened.

Although the preferred embodiments of the present invention have been described above in detail, the person skilled in the art should clearly understand that various modification and alteration to the present invention are possible. Any modification, equivalent replacement and improvement within the spirits and principles of the present invention all fall into the protection scope of the present invention.

1. An LED lamp unit, comprising an light-emitting body having a hollow tube shape, and a translucent cover enclosing the light-emitting body at its outside with a space there between, the light-emitting body and/or the translucent cover having LED light-emitting elements fixed on them, characterized in that: the two ends of the light-emitting body and the translucent cover have end caps fixed and connected to them, the end caps have opening holes at their centers which connect a hollow cavity inside the light-emitting body to external environment, at least one end of the light-emitting body is provided with an electrical connection component which extends out of the end caps, and the LED light-emitting elements on the light-emitting body are connected to the electrical connection component; and
the end cap at the end that has electrical connection component is provided with a circumferential surface which extends outwardly in the same direction as the extending direction of the light-emitting body and the translucent cover, and the circumferential surface is provided with ventilation holes which connect the hollow cavity inside the light-emitting body to outside air.

2. The LED lamp unit according to claim 1, wherein: the outer end of the circumferential surface of the end cap at the end that has electrical connection component is closed, and the outer end of the circumferential surface which is closed has a hole from which the electrical connection component protrudes.

3. The LED lamp unit according to claim 1, wherein: when only one end of the LED lamp unit has the electrical connection component, the end cap at the end that has no electrical connection component is also provided with a circumferential surface which extends outwardly in the same direction as the extending direction of the light-emitting body and the translucent cover, and the circumferential surface is provided with ventilation holes which connect the hollow cavity inside the light-emitting body to outside air.

4. The LED lamp unit according to claim 3, wherein: the outer end of the circumferential surface of the end cap at the end of the LED lamp unit that has no electrical connection component is closed.

5. The LED lamp unit according to claim 1, wherein: the outer surface of the light-emitting body is coated with reflective layer or fluorescent powder layer.

6. The LED lamp unit according to claim 1, wherein: the end caps are provided with grooves for accommodating and fixing the light-emitting body and the translucent cover respectively.

7. The LED lamp unit according to claim 1, wherein: the LED Light-emitting elements are fixed on the outer surface of the light-emitting body.
